(19) United States
(12) Patent Application Publication
(10) Pub. No.: US 2015/0090779 A1
(43) Pub. Date: Apr. 2, 2015

(54) EXAMINATION ROOM TABLE PAPER SYSTEM AND METHOD

(71) Applicant: Angela Jane Malone, Cincinnati, OH (US)

(72) Inventor: Angela Jane Malone, Cincinnati, OH (US)

(21) Appl. No.: 14/501,549

(22) Filed: Sep. 30, 2014

Related U.S. Application Data
(60) Provisional application No. 61/884,726, filed on Sep. 30, 2013.

(51) Int. Cl. G06F 17/30

(52) U.S. Cl. CPC G06F 17/30879; G06F 17/30887; G06F 17/30817
USPC 235/375

(57) ABSTRACT

A system and method for displaying information on mobile computing devices based on links encoded and printed on examination room table paper is presented. A mobile computing device can be configured to scan quick response codes and other codes on the paper and access servers across a network based on the decoded links. The links can be uniform resource locators or shortened uniform resource locators for retrieving data from the servers, such as video, audio, augmented reality layers, and web pages that the mobile computing device can display or otherwise present in a suitable format. The examination room table paper can be configured in a roll for use with exam benches typically present in an examination room, and can include activities for engaging children as well as advertisements for promoting sponsors, products and services.

### REFERENCE TO RELATED APPLICATIONS

This application claims priority to U.S. Provisional Patent Application No. 61/884,726 filed Sep. 30, 2013, which is hereby incorporated herein by reference in its entirety.

### TECHNICAL FIELD

The systems and methods described below relate generally to the field of disposable liner paper. More particularly, the systems and methods relate to the field of retrieving information from a server based on codes scanned from examination room table paper.

### SUMMARY

A system includes examination room table paper that has a code, such as a quick response or QR code, that can be scanned and that encoded a link to access a server, the server that stores data, and a computing device that is configured to scan one or more codes on the examination room table paper, access the server based on the link encoded in the scanned code, received a portion of the data stored on the server as received data, and present a representation of the data. The examination room table paper can include one or more activities and/or one or more advertisements. The examination room table paper can be configured in a roll for use with an exam bench such as an exam bench typically present in an examination room. The server can be a server of a social media website, a video server, an audio server, a picture server, a health care provider's server, and a cloud-based multimedia server such as a server hosted by an administrator of the system. A computing device can be a mobile computing device, a smartphone, a wireless communications device, a tablet, a laptop, a desktop personal computer, or an embedded computing device. The code can be a QR code, a near field communication or NFC-type code, a bar code, a two-dimensional bar code, or a uniform resource locator or URL. Scanning the code can include the operations of activating a camera of the computing device, capturing an image containing the code by the camera, determining the scanned code from the image that contains the code, and decoding the link from the scanned code. The link can be a uniform resource locator or a shortened uniform resource locator. Accessing the server based on the link in the scanned code can include launching a web browser in the computing device using the uniform resource locator as the address the web browser uses initially to request a web page. Accessing the server can include downloading a file from the server based at least in part on the link. For example a video clip or other file can be downloaded. Presenting a representation of the received data can be live video overlaid with augmented reality images when the received data is augmented reality type data. Presenting a representation of the received data can also be video that is displayed on a display of the computing device when the data includes video, an audio selection played through the audio interface when the data includes audio, and a browser screen that is displayed on the screen when the data is a web page.

A method includes scanning a code from an examination room table paper, determining a link from the scanned code, accessing a server across a network based in part on the link from the scanned code, receiving data from the server in response to the accessing operation, and presenting a representation of the received data. The examination room table paper can include activities and/or advertisements. Receiving data from the server can include receiving a video stream, an audio stream, an audio-video stream, an animation, a picture, a graphic illustration, a file such as a video file or other file, an augmented reality layer containing data for augmenting live video, and a web page. Presenting the data in suitable representation can include displaying live video display overlaid with augmented reality images, audibly playing an audio selection through an audio interface of the computing device, and displaying a browser screen on the display of the computing device. Scanning a code can include activating a camera of the computing device, capturing an image by the camera where the image contains the code, and determining, by the computing device, the scanned code from the image that contains the code.

A non-transitory computer readable medium includes instructions stored thereon that when executed by a processor causes the processor to perform the operations of obtaining an image of a QR code from exam bench paper, determining a URL from the QR code, receiving data from a resource at the address of the URL, and displaying received data on a display. The processors can further perform the operations of capturing an image from a camera, and determining the QR code from the image. The exam bench paper can include an advertisement and an activity for entertaining a child.

### BRIEF DESCRIPTION OF THE DRAWINGS

It is believed that certain embodiments will be better understood from the following description taken in conjunction with the accompanying drawings, in which like references indicate similar elements and in which:

FIG. 1 depicts a block diagram of an example examination room table paper system, according to one embodiment.

FIG. 2 depicts example examination room table paper, according to a first embodiment.

FIG. 3 depicts example examination room table paper, according to a second embodiment.

FIG. 4 depicts example examination room table paper, according to a third embodiment.

FIG. 5 depicts an example computing device, according to one embodiment.

FIG. 6 depicts an example screen of user interface of the examination room table paper system, according to one embodiment.

FIG. 7 depicts an example flow diagram of the examination room table paper system, according to one embodiment.

### DETAILED DESCRIPTION

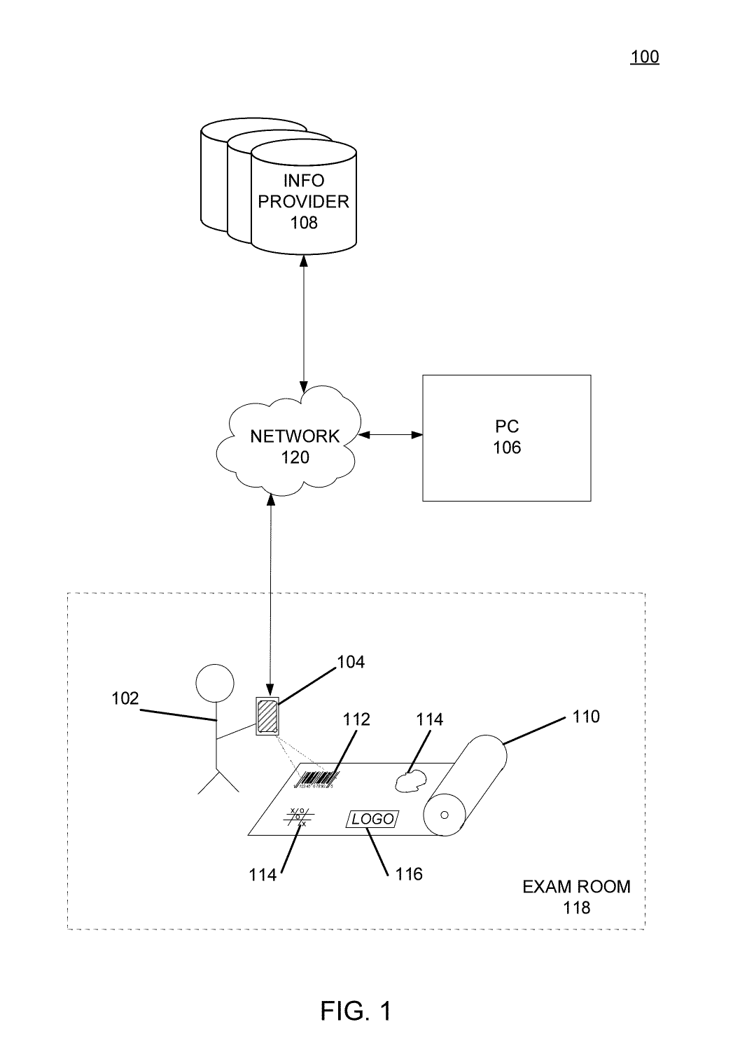

Various non-limiting embodiments of the present disclosure will now be described to provide an overall understanding of the principles of the structure, function, and use of systems and methods disclosed herein for an examination room table paper system. One or more examples of these non-limiting embodiments are illustrated in the selected examples disclosed and described in detail with reference made to FIGS. 1-7 in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

The systems, apparatuses, devices, and methods disclosed herein are described in detail by way of examples and with reference to the figures. The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment”, or “in an embodiment” in places throughout the specification are not necessarily all referring to the same embodiment. Furthermore, the particular features, structures or characteristics may be combined in any suitable manner in one or more embodiments.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context. It should be noted that although for clarity and to aid in understanding some examples discussed herein might describe specific features or functions as part of a specific component or module, or as occurring at a specific layer of a computing device (for example, a hardware layer, operating system layer, or application layer), those features or functions may be implemented as part of a different component or module or operated at a different layer of a communication protocol stack. Those of ordinary skill in the art will recognize that the systems, apparatuses, devices, and methods described herein can be applied to, or easily modified for use with, other types of equipment, can use other arrangements of computing systems such as client-server distributed systems, and can use other protocols, or operate at other layers in communication protocol stacks, than are described.

For simplicity, the description that follows will be provided by reference to “exam bench paper” or “examination room table paper”, which will be used interchangeably and which generally refer to paper placed on an exam bench or other table in an examination room, and that is changed by medical staff between patients to provide a clean sheet or area of paper for each new patient, as would be understood by one of ordinary skill in the art. As is to be clear to those skilled in the art, no aspect of the present disclosure is specifically limited to a specific type of exam bench, table, or paper type. Therefore, it is intended that the following description encompasses the use of the present disclosure with many other suitable forms of furnishings in a doctor's office or examination room, and including rolls of paper, sheets of paper, and the like.

The current average wait time in a health care facility is 21 minutes. Patients, especially children, can become anxious and restless while waiting for a health care professional. Diversions can provide entertainment and relax patients while waiting, which can result in a more productive visit. While typical diversions such as coloring books, magazines, and toys can be appropriate for waiting rooms, the examination room is not the place for clutter or mess. Examination room table paper systems in accordance with the present disclosure provide diversion activities and education of patients and caregivers.

FIG. 1 depicts a block diagram of an example examination room table paper system 100. In the example system 100, a person 102 waiting in an examination room 118 can use a computing device, such as a mobile computing device 104, to scan a code 112 on examination room table paper 110. The mobile computing device 104 can use the code 112 to link to, retrieve, or access information from an information provider 108 across a network 120.

Before a person 102, such as a patient, child, or caregiver, enters the examination room 118, medical staff can unroll new exam bench paper 110 onto an examination table, thus providing each new patient with a clean sheet when they enter the examination room 118. The exam bench paper 110 can include activities 114 such as useful information to read, age appropriate medical diagrams to look at, helpful medical recommendations, trivia, coloring activities, drawing activities, puzzle activities, game activities, word activities, and so forth. In a configuration, a person 102 can use crayon, washable crayons, markers, pencils, and so forth on the exam bench paper 110. The exam bench paper 110 can include an advertisement 116 such as a logo, advertiser or sponsor identification and/or information, an offer, and so forth.

The exam bench paper 110 can include a code 112, such as a quick reference code (QR code), a barcode, a near field code (NFC), or other code as would be understood by one of ordinary skill in the art. Each code 112 on the exam bench paper 110 can link to a unique experience, and can include features such as video clips, animations, surveys, coupon offers, advertising, examination information, hospital or care center information, doctor and health care provider information, insurance information, and so forth. In a configuration, a code 112 can encode information directly and present that information without requiring linking across a network 120 to an information provider 108. For example, some codes 112 can provide short text information, such as answers to trivia questions provided in an activity 114. For example, two-dimensional bar codes can be used to encode text and other data directly without requiring a link or reference to a data store.

One or more persons 102 may wait in the examination room 118 for a period of time until a health care provider arrives. While waiting, a person can 102 can view an advertisement 116, perform an activity 114, or scan a code 112 on the exam bench paper 110 with a mobile computing device 104.

A mobile computing device 104 can be a smart phone, an iPhone™, an Android™-based device, a tablet, a laptop, a wireless communications device, or any other suitable mobile computing platform as would be understood by one of ordinary skill in the art. The mobile computing device 104 can include software and/or hardware that enable the mobile computing device 104 to read the code 112 and link to information provided by one or more information providers 108. The mobile computing device 104 can execute software that when executed cause processors and other hardware in the mobile computer device 104 to execute machine-readable program code for performing operations. Example operations include reading the code 112, determining the information provided in the code 112, linking to or accessing information across a network 120 from an information provider 108, and presenting that information in a suitable format on the mobile computing device 104 to the person 102.

The software can comprise one or more modules, one or more stand-alone applications or applets, and can include operations performed by a web browser such as Safari™, Opera™, Google™ Chrome™, Internet Explorer™, or the like executing on a client device such as the mobile computer device 104 or desktop computing device devices 106. A web browser can retrieve web pages across the network 120, for example web pages that include executable code such as scripts, JAVA™, hypertext markup language (HTML), and so forth. In a configuration, the mobile computing device 104 can include hardware and/or software for scanning and determining the code 112, for example a bar code reader, a camera for imaging the code 112, and/or software for determining the data represented by the code 112.

In a configuration, the computing device can be a desktop computing device 106 or any other suitable computing device. For example, a person 102 may, after leaving the health care facility, use information presented on the exam bench paper 110 to access the information provider 108. For example, the person 102 can take a picture of the exam bench paper 110 or take a section of the exam bench paper 110 home and access the information from an information provider 108 when at home using a desktop computing device 106, or any other computing device such as a mobile device 104.

The network 120 can be the Internet, a cloud-based server, a data link to a server, an extranet, an intranet, a mobile network, or any other suitable network or combination of networks as would be understood by one of ordinary skill in the art. The communication devices, such as the mobile computing device 104 and desktop computing device 106, can communicate with the information providers 108 using any suitable communication channels and protocols. For example, any computing devices of the examination room table paper system 100 can use the Internet 120 as their communication network. Other suitable communication channels and protocols can include, without limitation, those used in mobile wireless communications and wired networked connections.

An information provider 108 can be a server, for example a server of the health care facility, a cloud-based server, a server managed by an administrator of the examination room table paper system 100, a public database, a social media website, a server of an advertiser or sponsor of the exam bench paper 110, and so forth. One or multiple information providers 108 can be accessed by the mobile computing device 104 using links encoded in the codes 112. In a configuration, each information provider 108 can be accessed via an alias provided in the code 112. For example, the code 112 can provide a shortened uniform resource locator (URL) that is resolved by a URL shortening service into a full URL for accessing the information of the information provider 108.

The information provider 108 can receive requests and send data and information to the mobile computing device 104. Among other operations, the data and information sent to the mobile computing device 104 can provide any of the following non-limiting operations:

Tell patient success stories.
Offer words of encouragement from celebrities and childhood heroes.
Take patients on a video tour of the facility.
Showcase stories, poetry and art from patients.
Link to mobile apps.
Ask patients to share ideas for how to help other children.
Show a two minute video of each physician's life outside of the hospital, so the patient can get to know a little about what their doctor is like and feel more comfortable.
Offer a collection of easy, nutritional recipes that kids can make.
Link to a simple nutrition calculator app.
Link to sites for building interest for commemorative days, weeks and months.
Promote upcoming community or hospital events, fun runs and benefits.
Collect email addresses for an e-newsletter.
Explain terms that patients and parents should know.
Share news of recent endowments and other developments.
Explain how x-rays work.
Announce recent awards and recognitions.
Feature health quizzes, health facts or fun trivia questions.
Provide a space for vendors to promote products using value-added experiences.
Offer instant coupons for food and product categories highlighted by health facts.
Highlight foundation and charitable works.
Promote seasonal flu shots.
Link to animated medicine games.
Show video about how photos are processed, how aspirin is manufactured, or a day in the life of a delivery driver.
Promote recycling programs.
Access an educational video about a procedure/condition.
Link to an ebook, audio book, or game.
Provide forms to share preferences, contact info, and satisfaction levels.
Suggest services and links to advertiser/sponsor websites.
Provide information about events/programs that relate to them in their area.
Suggest opportunities to save money on products/services.
Provide instant info on their health care facility.
Gather valuable patient preferences and survey data.
Feature third party advertising.
Distribute instant coupons.
Play special messages from celebrities or spokespeople.
Sell tickets to special events.
Provide special offers for local restaurants or partner stores.
Incorporate connections from social media such as Facebook™, Pinterest™ and Instagram™.
Solicit charitable donation solicitations.
Display safety messages.
Offer parenting magazine subscriptions.
Provide interactive ebook samples and excerpts.
Stream podcasts.
Display fact sheets and tip sheets.
Show families of proprietary characters.
Link to family, medical and general interest blogs.
   The data and information sent to the mobile computing device 104 can cause the mobile computing device 104 to perform other operations or functions as well, as would be understood by one of ordinary skill in the art.

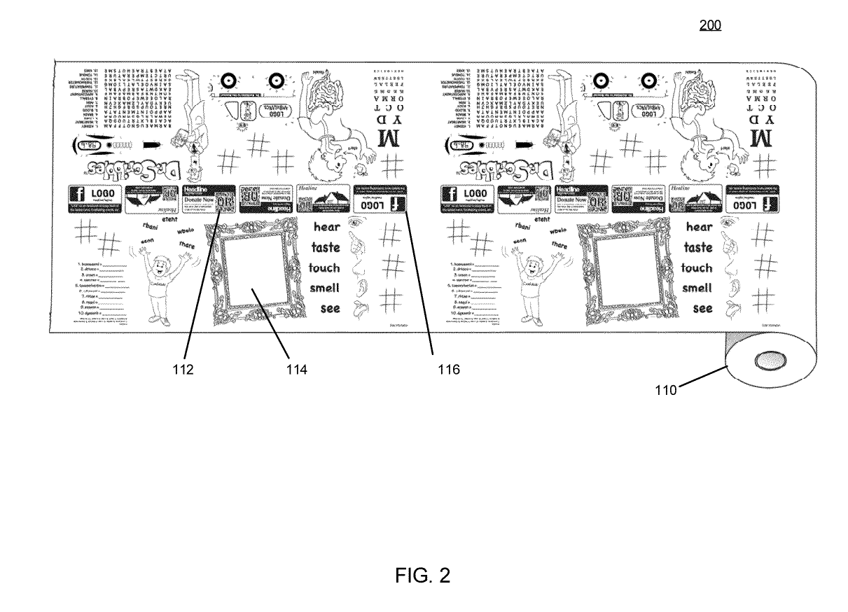

Referring now to FIGS. 2-4, example examination room table paper 200, 300, 400 is presented. In FIG. 2, a first embodiment of examination room table paper 200 is presented. The examination room table paper 200 comprises a roll of exam bench paper 110 upon which is printed one or more codes 112 such as QR codes, as illustrated, bar codes (not illustrated), or other codes. In an alternate embodiment, the code can be a uniform resource locator or URL that is printed on the examination room table paper 200 and that can be scanned by a computing device or entered manually by a user 102 into a web browser. The examination room table paper 200 further comprises activities 114 such as tic-tac-toe, age appropriate medical and educational diagrams, trivia, facts, figures for coloring, crosswords, and so forth as described above. The examination room table paper 200 further comprises advertisements 116 such as sponsors, advertiser, logos, and so forth as described above. In a configuration, the examination room table paper 200, 300, 400 can be designed to be specific to the type of medical treatment typically provided in the examination room 118 or medical facility. For example, a pediatric examination room 118 can include age appropriate activities 114, while a geriatric examination room 118 can include larger print and different content to accommodate elderly patients. An examination room 118 for diagnosing and treating military personnel can include information relevant to injuries typical in the military.

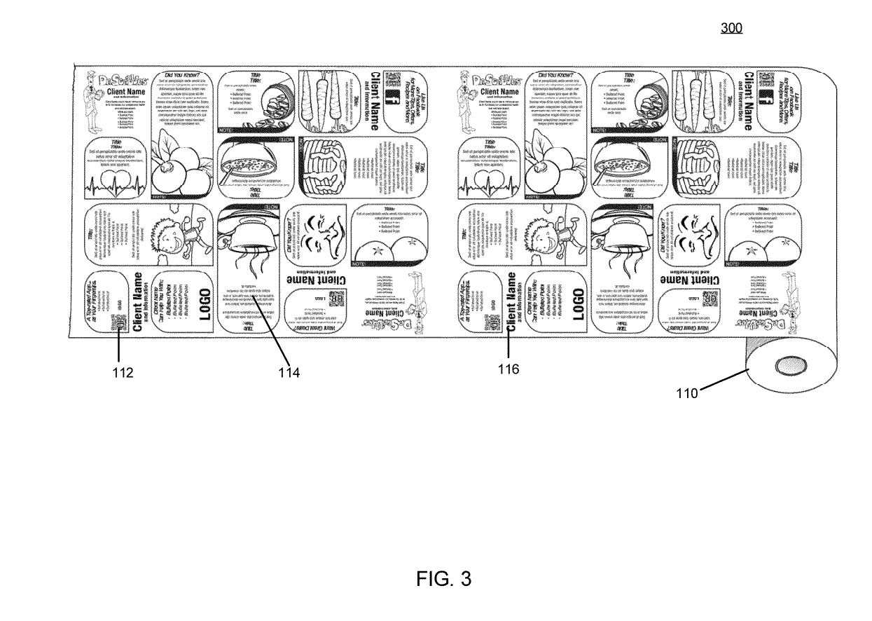

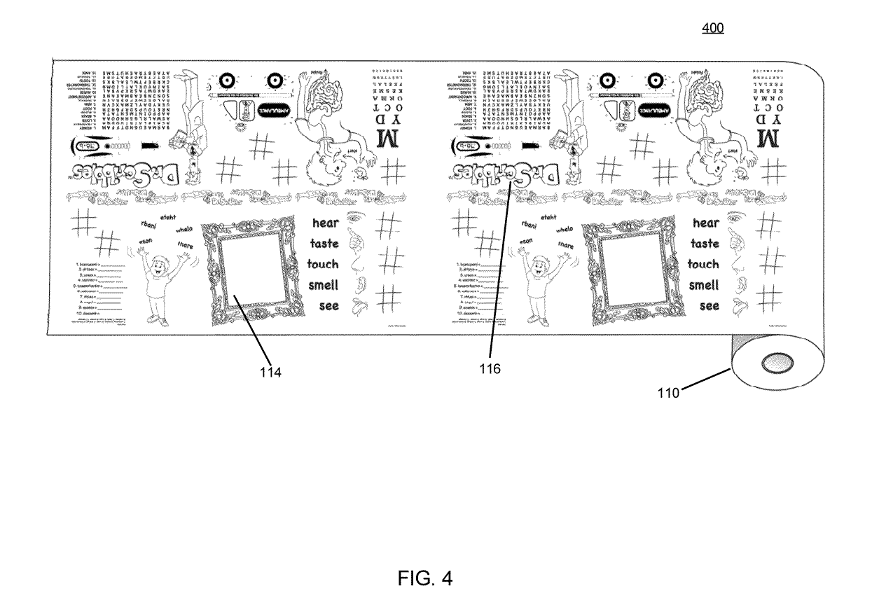

In FIG. 3 a second embodiment of examination room table paper 300 is presented. The examination room table paper 300 comprises a roll of exam bench paper 110 upon which is printed one or more codes 112, activities 114, and advertisements 116. The activities 114 and content can be configured to be specific to the advertiser or sponsor in the advertisements 116. In FIG. 4 a third embodiment of examination room table paper 400 is presented. The examination room table paper 400 comprises a roll of exam bench paper 110 upon which activities 114 and advertisements 116. In an embodiment, the advertisements 116 can be directed to the provider of the examination room table paper 400.

In a configuration, the examination room table paper system 100 can include a printer and database for on-demand printing of the examination room table paper 200, 300, 400. In alternate embodiments, the system 100 can print paper appropriate for other uses, such as precut food tray liners, or other fix length sheets or continuous rolled sheets as would be appropriate for the particular use such as, for example, in schools. It will be appreciated that such systems and methods can be used in any suitable environment such as, for example, military settings, school settings, restaurants, airlines, cruise lines, or the like.

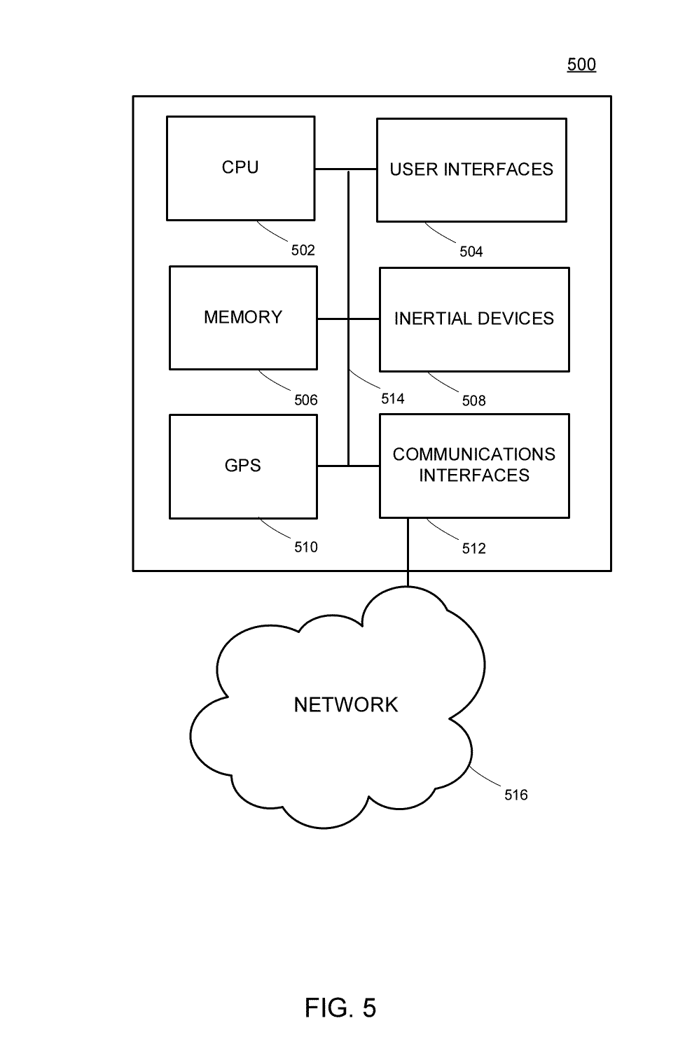

Referring now to FIG. 5, an example computing device 500 of the examination room table paper system 100 is presented. The processes described herein can be performed on or between one or more computing devices 500. A computing device 500 can be a server, a computing device that is integrated with other systems or subsystems, a mobile computing device 104, a desktop computing device 106, a networked database, a social media system, a cloud-based computing capability, and so forth. The computing device 500 can be any suitable computing device as would be understood in the art, including without limitation, a custom chip, an embedded processing device, a tablet computing device, a personal data assistant (PDA), a desktop, a laptop, a microcomputer, a minicomputer, a server, a mainframe, or any other suitable programmable device. In various embodiments disclosed herein, a single component can be replaced by multiple components and multiple components can be replaced by a single component to perform a given function or functions. Except where such substitution would not be operative, such substitution is within the intended scope of the embodiments.

Each computing device 500 includes one or more processors 502 that can be any suitable type of processing unit, for example a general purpose central processing unit (CPU), a reduced instruction set computer (RISC), a processor that has a pipeline or multiple processing capability including having multiple cores, a complex instruction set computer (CISC), a digital signal processor (DSP), an application specific integrated circuits (ASIC), a programmable logic devices (PLD), and a field programmable gate array (FPGA), among others. The computing resources can also include distributed computing devices, cloud computing resources, and virtual computing resources in general.

The computing device 500 also includes one or more memories 506, for example read only memory (ROM), random access memory (RAM), cache memory associated with the processor 502, or other memories such as dynamic RAM (DRAM), static ram (SRAM), programmable ROM (PROM), electrically erasable PROM (EEPROM), flash memory, a removable memory card or disk, a solid state drive, and so forth. The computing device 500 also includes storage media such as a storage device that can be configured to have multiple modules, such as magnetic disk drives, floppy drives, tape drives, hard drives, optical drives and media, magneto-optical drives and media, compact disk drives, Compact Disk Read Only Memory (CD-ROM), Compact Disk Recordable (CD-R), Compact Disk Rewriteable (CD-RW), a suitable type of Digital Versatile Disk (DVD) or BluRay disk, and so forth. Storage media such as flash drives, solid state hard drives, redundant array of individual disks (RAID), virtual drives, networked drives and other memory means including storage media on the processor 502, or memories 506 are also contemplated as storage devices. It can be appreciated that such memory can be internal or external with respect to operation of the disclosed embodiments. It can be appreciated that certain portions of the processes described herein can be performed using instructions stored on a computer-readable medium or media that direct a computer system to perform the process steps. Non-transitory computer-readable media, as used herein, comprises all computer-readable media except for transitory, propagating signals.

Network and communication interfaces 512 can be configured to transmit to, or receive data and information from, other computing devices 500 across a network 516. The network and communication interfaces 512 can be an Ethernet interface, a radio interface, a Universal Serial Bus (USB) interface, or any other suitable communications interface and can include receivers, transmitter, and transceivers. For purposes of clarity, a transceiver can be referred to as a receiver or a transmitter when referring to only the input or only the output functionality of the transceiver. Example communication interfaces 512 can include wired data transmission links such as Ethernet and TCP/IP. The communication interfaces 512 can include wireless protocols for interfacing with private or public networks 516. For example, the network and communication interfaces 512 and protocols can include interfaces for communicating with private wireless networks 516 such as a WiFi network, one of the IEEE 802.11x family of networks, or another suitable wireless network. The network and communication interfaces 512 can include interfaces and protocols for communicating with public wireless networks 216, using for example wireless protocols used by cellular network providers, including Code Division Multiple Access (CDMA), Global System for Mobile Communications (GSM), and any of the long term evolution (LTE) generation of wireless protocols. A computing device 500 can use network and communication interfaces 512 to communicate with hardware modules such as a database or data store, or one or more servers or other networked computing resources. Data can be encrypted or protected from unauthorized access.

Mobile computing devices can include inertial components 508 and global positioning systems components (GPS components 510). The inertial components 508 and GPS components 510 can determine the terrestrial position of the mobile computing devices. Mobile computing devices can use the inertial components 508 and GPS components 510 in combination with radio transmissions received via the network and communication interfaces 512 to accurately determine the position of a mobile computing device. The position can be transmitted to other computing systems. For example, the position of a mobile computing device can be used to determine when the patient or person 102 is at the health care facility or in the examination room 118. The position can be used in a geo-fencing fashion to determine when the patient arrived at the health care facility, when the patient entered and exited the examination room 118, and providing trending information and estimates of wait times for patients. In another embodiment, the inertial components 108 can be used to provide augmented reality features to an activity 114 or other feature of the exam bench paper 110. For example, using the inertial components 508 and a camera element of the mobile computing device 104, the mobile computing device 104 execute an appropriate app or software to visually recognize elements on the exam bench paper 110 and overlay digital representations on the screen of the mobile computing device 104 or other associated viewing devices linked to the mobile computing device 104. In a configuration, augmented reality can be used to provide answers to an activity 114, for example hints or answers for a crossword puzzle, or present animations, such as a 3-D animation of a character that could be made to appear to be in the room with the patient or a child accompanying an adult.

In various configurations, the computing device 500 can include a system bus 514 for interconnecting the various components of the computing device 500, or the computing device 500 can be integrated into one or more chips such as programmable logic device or application specific integrated circuit (ASIC). The system bus 514 can include a memory controller, a local bus, or a peripheral bus for supporting input and output devices 504, and communication interfaces 512. Example input and output devices 504 include keyboards, keypads, gesture or graphical input devices, motion input devices, touchscreen interfaces, one or more displays, audio units, voice recognition units, vibratory devices, computer mice, and any other suitable user interface.

The processor 502 and memory 506 can include nonvolatile memory for storing computer-readable instructions, data, data structures, program modules, code, microcode, and other software components for storing the computer-readable instructions in non-transitory computer-readable mediums in connection with the other hardware components for carrying out the methodologies described herein. Software components can include source code, compiled code, interpreted code, executable code, static code, dynamic code, encrypted code, or any other suitable type of code or computer instructions implemented using any suitable high-level, low-level, object-oriented, visual, compiled, or interpreted programming language.

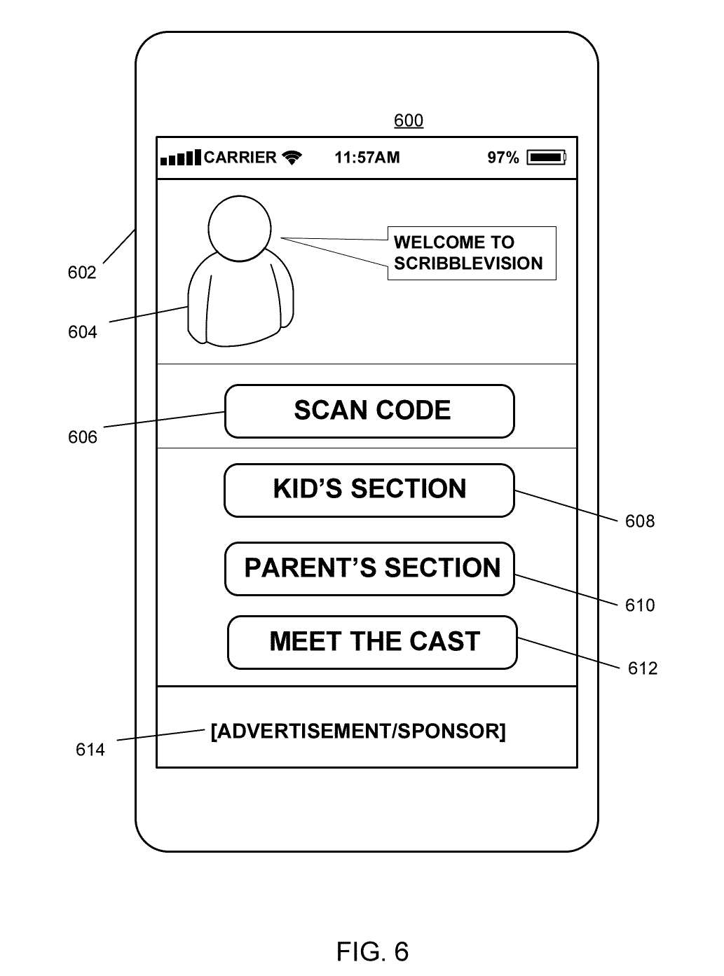

FIG. 6 depicts an example user interface 600 of the examination room table paper system 100. In an embodiment, the user interface 600 can be presented on a mobile computing device 602. The user interface 600 can include a welcome message 604, for example a character with a friendly bubble that includes the welcome message 604. A user can click on a scan code button 606 that causes the mobile computing device 602 to scan a code 112 (see FIGS. 1-4) on the exam bench paper 110 (see FIGS. 1-4.) A user can click on a kids section button 608 that presents another user interface with child-appropriate information or mini games, for example activities 114 similar to those on the exam bench paper 110 of FIGS. 1-4. A user can click on a parent's section 610 that can present another user interface with adult-appropriate information and tools, to access such features as surveys, patient feedback, appointment setup and reminders, directory information, health care facility information, health care provider and physician information, wait time information, insurance information, and so forth. A user can click on a meet the cast button 612 to view a configurable presentation of characters for children, and/or pictures and names of health care providers and physicians. The user interface can include an advertisement 614. The advertisement 614 can be an image, a logo, a link, or any other suitable form of digital advertisement or sponsor message. In various configurations, the user interface can be a web page, a mobile web page, a dedicated mobile app, or any other suitable user interface as would be understood by one of ordinary skill in the art.

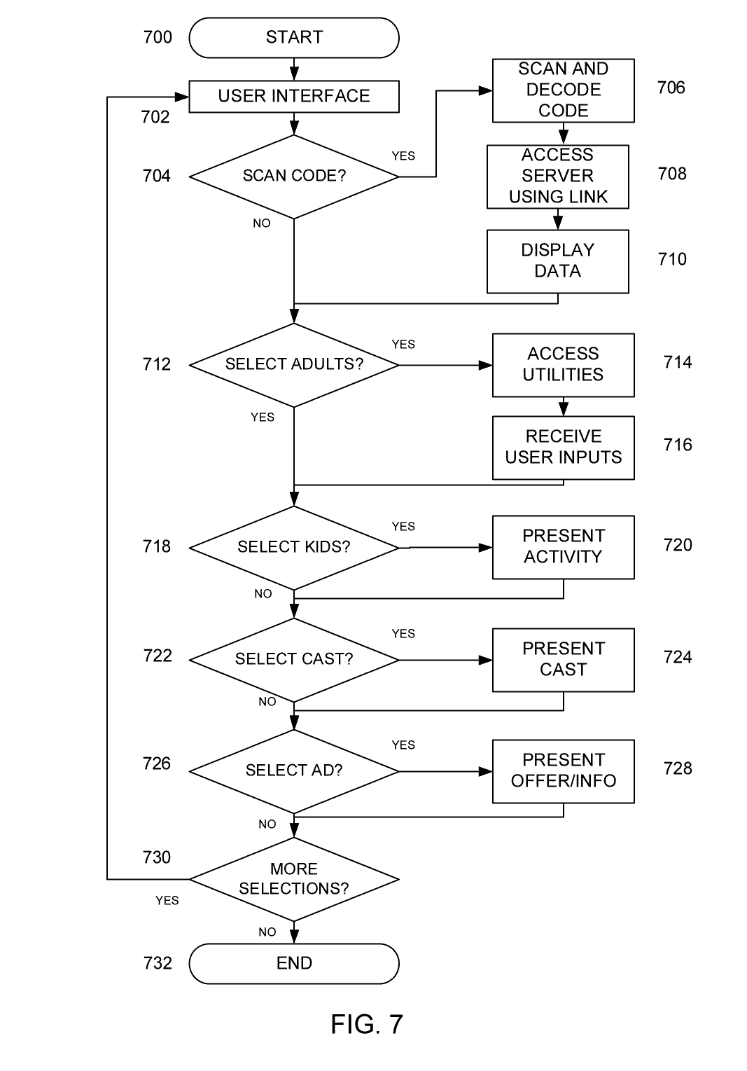

FIG. 7 depicts an example flow diagram of the example examination room table paper system 100. Processing begins at start block 700 labeled START and continues to process block 702.

In process block 202, the user is presented with a user interface that includes selectable options such as a scan code button, an adult selection button, a kids selection button, a cast selection button, and an advertisement link, among other possible options and selections as would be understood by one or ordinary skill in the art. The user interface can be a web page using, for example, hypertext markup language (HTML) and Java scripts, or a dedicated applet or application, or any other suitable interfacing means as would be known or understood in the art. Processing continues to decision block 704.

In decision block 704, if the user selects a scan code button, then processing continues to process block 706, otherwise processing continues to decision block 712.

In process block 706, a code 112 is scanned from the exam bench paper 110. The code 112 can be a QR code, bar code, or any other suitable code as described above. The code can be scanned with camera, such as a camera of a mobile computing device 104. The code can be scanned with a third party application executing on the mobile computing device 104. The code can be decoded to determine a link, such as a URL, to a resource such as a server of an information provider 108. Processing continues to process block 708.

In process block 708, the link is used to access an information resource, such as a server of an information provider 108. Data referenced by the link can be received by the mobile computing device 104. For example, when the link is a URL, a web browser can be launched by the mobile computing device 104 and data can be received for displaying in a web browser screen or window. Processing continues process block 710.

In process block 710, the received data can be presented to the user using the mobile computing device 104. For example, if the data is a web page then the mobile computing device 104 can display the web page in a web page. For example, the link could be a link to a social media website, or a website containing multimedia such as video, audio, text, graphics, pictures, animations and so forth as would be understood by one of ordinary skill in the art. In other configurations the data could link to a video server, a streaming music service, a picture server, and so forth, and the mobile computing device 104 can present the received data in the appropriate audio or video format. In yet another configuration, the received data can be augmented reality data, in which case the mobile computing device 104 can overlay the augmented reality data over live video from a camera and presented the combined video on the screen of the mobile computing device 104 as would be understood by one of ordinary skill in the art. Processing continues to decision block 712.

In decision block 712, if the user selects the adult information button, then processing continues to process block 714, otherwise processing continues to decision block 718.

In process block 712, the user can select a desired utility to access, for example the user can access a survey system, an appointment calendaring and reminder application, social media websites, and other information sources. Processing continues to process block 716.

In process block 716, the user can optionally provide inputs to one or more of the utility applications. For example, if the user is accessing the appoint calendaring and reminder application referenced in process block 718, then the user can set up appointments and schedule reminders such as email or text reminders. If the user is accessing a survey, the user can enter survey responses. If the user is accessing social media, then the user can check in, post messages, and other social media type activities. Processing continues to decision block 718.

In decision block 718, if the kids button is selected, then processing continues to process block 720, otherwise processing continues to decision block 722.

In process bock 720, the user can be presented with a child appropriate activity 114 or child appropriate information such as videos, animations, mini games, and so forth as described above. Processing continues to decision block 722.

In decision block 722, if the cast button is selected, then processing continues to process block 723, otherwise processing continues to decision block 726.

In process block 724, the user can be presented with video, images, pictures, animations, and/or information about the cast. The cast can include characters for children. For example, a user can be presented with a scrollable display of characters and can tap on a particular character to see a picture, animation, video, or other information about the character. In an embodiment, the case can include health care providers and physicians as described above. Processing continues to decision block 726.

In decision block 726, if the advertisement includes a link or button and the user selects the link or button, the processing continues to process block 728, otherwise processing continues to decision block 730.

In process block 728, the user can be presented with information about the sponsor or advertiser and/or can be presented with a coupon or offer. In a configuration, a link can open a web browser to a website of the sponsor or advertiser. In a configuration, a record can be created to track the user's selection of the advertisement, for example to monetize the users clicking on the advertiser's link. Processing continues to decision block 730.

In decision block 730, if the user continues to use the user interface, then processing continues back to the user interface of process block 702. Otherwise, processing terminates in end block 732 labeled END.

These and other embodiments of the systems and methods can be used as would be recognized by those skilled in the art. The above descriptions of various systems and methods are intended to illustrate specific examples and describe certain ways of making and using the systems disclosed and described here. These descriptions are neither intended to be nor should be taken as an exhaustive list of the possible ways in which these systems can be made and used. A number of modifications, including substitutions of systems between or among examples and variations among combinations can be made. Those modifications and variations should be apparent to those of ordinary skill in this area after having read this disclosure.

What is claimed is:

1. A system, comprising:
an examination room table paper, further comprising
at least one scannable code that includes an encoded link;
a server comprising stored data; and
a computing device configured to
scan the at least one code from the examination room table paper,
access the server based on the link in the scanned code,
receive, as received data, at least a portion of the stored data from the server in response to the access operation, and
present a representation of the received data.

2. The system of claim 1, wherein the examination room table paper further includes one or more of
an activity, or
an advertisement.

3. The system of claim 1, wherein the examination room table paper is in a rolled format and is configured to be used with an exam bench.

4. The system of claim 1, wherein the server is selected from the group consisting of a social media website, a video server, an audio server, a picture server, a health care provider server, and a cloud-based multimedia server.

5. The system of claim 1, wherein the computing device is selected from the group consisting of a mobile computing device, a smartphone, a wireless communications device, a tablet, a laptop, a desktop, and an embedded computing device.

6. The system of claim 1, wherein the at least one scannable code is selected from the group consisting of a quick response code, a near field code, a bar code, a two-dimensional bar code, and a uniform resource locator.

7. The system of claim 1, wherein the computing device is further configured to scan the at least one code by performing the operations of:
activating a camera of the computing device;
capturing an image containing the code by the camera;
determining the scanned code from the image containing the code by the computing device; and
decoding the link from the scanned code.

8. The system of claim 1, wherein the link is a uniform resource locator.

9. The system of claim 8, wherein the link is a shortened uniform resource locator.

10. The system of claim 8, wherein accessing the server based on the link in the scanned code further comprises:
launching a web browser that includes the uniform resource locator as the address from which to request a web page.

11. The system of claim 1, wherein accessing the server based on the link in the scanned code further comprises:
downloading a file from the server based at least in part on the link.

12. The system of claim 1, wherein the representation of the received data is selected from the group consisting of
a live video display overlaid with augmented reality images when the received data is augmented reality data,
a video presented on a display of the computing device when the received data includes video,
an audio selection presented through the audio interface of the computing device when the received data includes an audio selection, and
a browser screen on the display of the computing device when the received data is a web page.

13. A method, comprising:
scanning a code from an examination room table paper;
determining a link from the scanned code;
accessing a server across a network based at least in part on the link;
receiving data from the server in response to the accessing operation; and
presenting a representation of the received data.

14. The method of claim 13, wherein the examination room table paper further comprises one or more activities or advertisements.

15. The method of claim 13, wherein receiving data from the server further comprises receiving one or more of a video stream, an audio stream, an audio-video stream, an animation, a picture, a graphic illustration, a file, an augmented reality layer, and a web page.

16. The method of claim 15, wherein presenting a representation of the received data further comprises:
displaying a live video display overlaid with augmented reality images when the received data is augmented reality data,
displaying a video on a display of a computing device when the received data includes video,
audibly playing an audio selection through an audio interface of the computing device when the received data includes an audio selection, and
presenting a browser screen on the display of the computing device when the received data is a web page.

17. The method of claim 13, wherein scanning a code further comprises:
activating a camera of a computing device;
capturing an image containing the code by the camera; and
determining the scanned code from the image containing the code by the computing device.

18. A non-transitory computer readable medium includes instructions stored thereon that when executed by a processor causes the processor to perform the operations of:
obtaining an image of a quick response code from an exam bench paper;
determining a uniform resource locator from the quick response code;
receiving data from a resource addressed in the uniform resource locator;
displaying the received data on a display.

19. The non-transitory computer readable medium of claim 18, wherein obtaining an image of the quick response code further includes the processor executing instructions to
capture an image from a camera, and
determine the quick response code from the image.

20. The non-transitory computer readable medium of claim 18, wherein the exam bench paper further includes at least one advertisement and at least one activity for entertaining a child.
